(19) United States
(12) Patent Application Publication
(10) Pub. No.: US 2025/0247478 A1
(43) Pub. Date: Jul. 31, 2025

(54) STORAGE MEDIUM STORING APPLICATION PROGRAM, INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: KAZUYUKI SAITO, Kanagawa (JP)

(21) Appl. No.: 19/038,094

(22) Filed: Jan. 27, 2025

(30) Foreign Application Priority Data
Jan. 29, 2024 (JP) 2024-010796

(51) Int. Cl. H04N 1/00

(52) U.S. Cl. CPC H04N 1/00503; H04N 1/0048; H04N 1/00941

(57) ABSTRACT

A non-transitory computer-readable storage medium storing an application program for causing an information processing apparatus to execute a method of supporting general-purpose software incorporated in an operating system in advance by executing the application program. FAX capabilities information of a printer is acquired. Settings of functions based on the FAX capabilities information are received. The general-purpose software is caused to generate image data based on the settings. The printer is caused to execute processing for transmitting the image data by FAX.

### BACKGROUND OF THE INVENTION

### Field of the Invention

The present invention relates to a storage medium storing an application program, an information processing apparatus, and a method of controlling the information processing apparatus.

### Description of the Related Art

In recent years, in Windows (registered trademark), there is provided general-purpose software (hereinafter referred to as a “standard driver”) that can be applied to various types of image processing apparatuses provided by different makers. Such a standard driver is incorporated in an OS in advance and is made usable when a desired image processing apparatus is connected to an information processing apparatus equipped with the OS. Therefore, it is not necessary to separately install a printer driver specific to each maker, which increases the convenience. However, when the standard driver is applied to various types of image processing apparatuses provided by a variety of makers, only standard functions can be used, but functions unique to each maker cannot be used. To overcome such an inconvenience, an extension application that extends the functions of such a standard driver has been developed.

Incidentally, there has been proposed a technique of displaying, on an information processing apparatus, a FAX setting UI for causing an image processing apparatus connected to the information processing apparatus to execute FAX transmission processing (see e.g. Japanese Laid-Open Patent Publication (Kokai) No. 2023-80177).

However, in the technique disclosed in Japanese Laid-Open Patent Publication (Kokai) No. 2023-80177, the FAX setting UI formed only by setting items of the standard FAX functions is displayed regardless of whether or not the image processing apparatus connected to the information processing apparatus is equipped with not only the standard FAX functions but also FAX functions unique to its maker. Therefore, a user cannot make FAX settings suited to the connected image processing apparatus.

### SUMMARY OF THE INVENTION

In a first aspect of the present invention, there is provided a non-transitory computer-readable storage medium storing an application program for causing an information processing apparatus to execute a method of supporting general-purpose software incorporated in an operating system in advance by executing the application program, the method comprising acquiring FAX capabilities information of an image processing apparatus, receiving settings of functions based on the FAX capabilities information, causing the general-purpose software to generate image data based on the settings, and causing the image processing apparatus to execute processing for transmitting the image data by FAX.

Further features of the present invention will become apparent from the following description of exemplary embodiments (with reference to the attached drawings).

### BRIEF DESCRIPTION OF THE DRAWINGS

FIG. 1 is a network diagram showing an example of a configuration of a printing system including a client terminal as an information processing apparatus according to the present embodiment.

FIGS. 2A to 2E are block diagrams showing an example of hardware configurations of components of the printing system according to the present embodiment.

FIG. 3 is a block diagram schematically showing a software configuration of the client terminal appearing in FIG. 1.

FIG. 4A is a sequence diagram of a FAX transmission control process executed by the printing system shown in FIG. 1.

FIG. 4B is a continuation of the sequence diagram of shown in FIG. 4A.

FIG. 5 is a diagram showing an example of a FAX transmission result details screen displayed on a display section appearing in FIG. 2A.

FIG. 6 is a flowchart of a setting UI display control process in a step S415 in FIG. 4A.

FIGS. 7A to 7C are diagrams each showing an example of a FAX setting UI.

FIGS. 8A and 8B are diagrams each showing an example of a printing setting UI.

FIG. 9 is a flowchart of a PDL type determination process in a step S427 in FIG. 4B.

FIG. 10 is a block diagram schematically showing a software configuration of a client terminal as an information processing apparatus according to a second embodiment.

FIG. 11A is a sequence diagram of a FAX transmission control process executed by the printing system according to the second embodiment.

FIG. 11B is a continuation of the sequence diagram of shown in FIG. 11A.

### DESCRIPTION OF THE EMBODIMENTS

The present invention will now be described in detail below with reference to the accompanying drawings showing embodiments thereof. First, a printing system including an information processing apparatus according to a first embodiment of the present invention will be described.

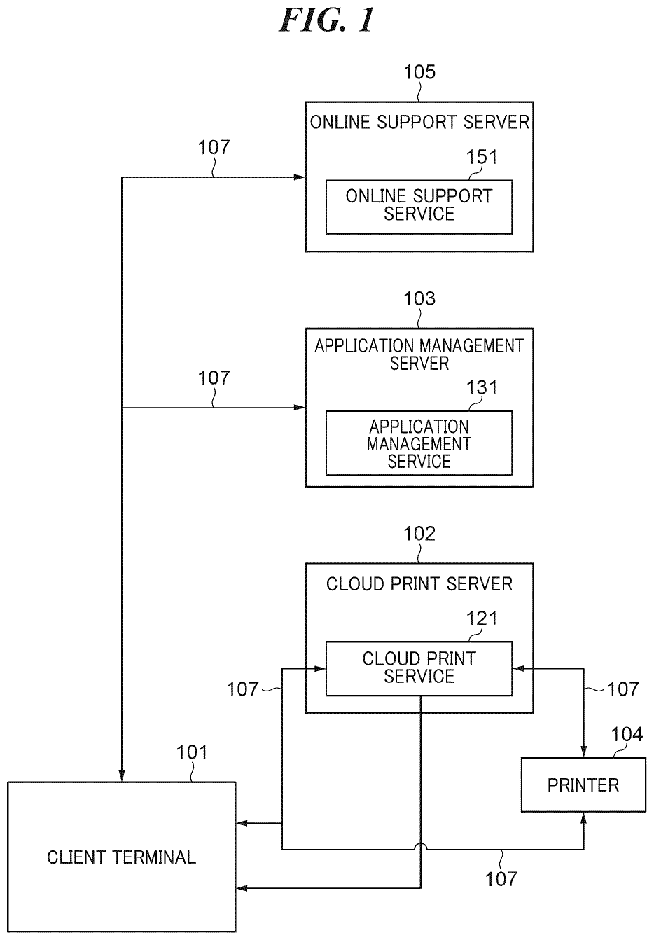

FIG. 1 is a network diagram showing an example of a configuration of the printing system including a client terminal 101 as the information processing apparatus according to the present embodiment. In this printing system, the client terminal 101, a cloud print server 102, an application management server 103, a printer 104, and an online support server 105 are connected via a network 107.

Note that although in FIG. 1, the printing system includes the client terminal 101 and printer 104 each as a single unit, the client terminal 101 and the printer 104 each as a plurality of units.

Further, each of the cloud print server 102, the application management server 103, and the online support server 105 can be a server system formed by a plurality of communication apparatuses. By configuring each server as the server system formed by a plurality of communication apparatuses, it is possible to distribute the processing load among the plurality of communication apparatuses.

Further, the cloud print server 102, the application management server 103, and the online support server 105 can be virtually configured within a physically single communication apparatus.

As the network 107, a WAN, such as the Internet, is assumed for connection to a cloud service, but the present printing system can be provided within an environment in which all components are connected to an in-company LAN or the like.

The client terminal 101 is an information processing apparatus, such as a PC, a tablet, and a smartphone, and is a terminal directly operated by a user. Desired application software can be executed on the client terminal 101.

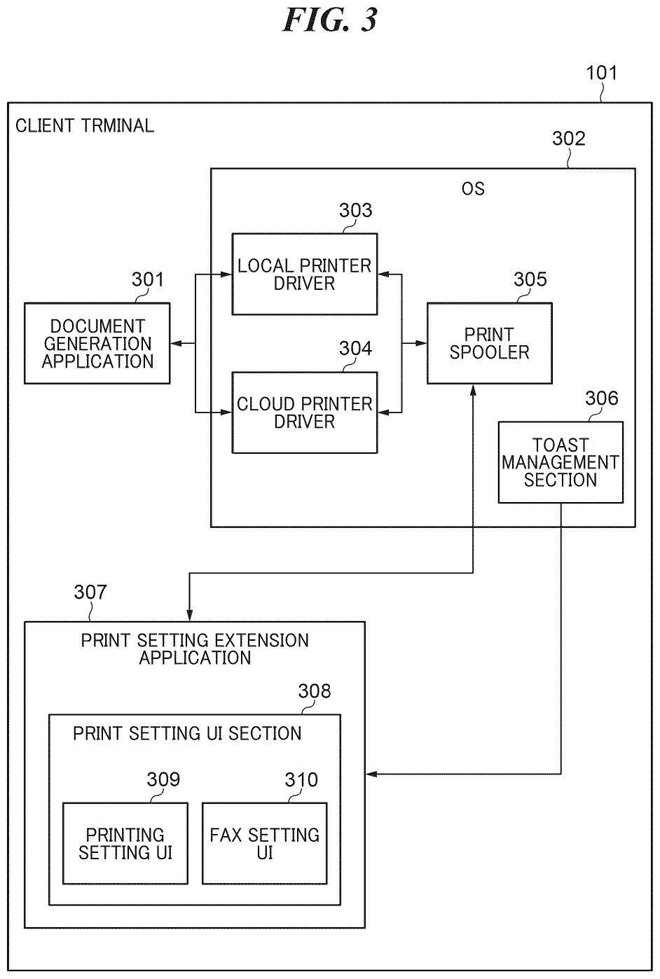

The printer 104 is a device that performs printing on a recording medium, such as a sheet, and is an image processing apparatus that converts print data received via the network 107 to image data and prints the image data. The printer 104 receives print data generated by a cloud printer driver 304 (cloud general-purpose software), described hereinafter with reference to FIG. 3, of the client terminal 101 via the cloud print server 102. Further, the printer 104 receives print data generated by a local printer driver 303 (general-purpose software), described hereinafter with reference to FIG. 3, of the client terminal 101 without using the cloud print server 102. Further, the printer 104 is equipped with a FAX (facsimile) communication function, acquires FAX transmission data generated by the client terminal 101 from the client terminal 101, and transmits this FAX transmission data to an apparatus designated by a user by FAX.

The cloud print server 102 receives a print instruction and print data from the outside. Then, the cloud print server 102 transmits the received print data to the designated printer 104.

The application management server 103 is a server apparatus that provides an application management service 131 and holds and manages a variety of applications. The application management server 103 receives application identification information and a download request from the client terminal 11 and transmits an application identified based on the received identification information to the client terminal 101.

The online support server 105 is a server apparatus that provides an online support service 151. The online support service 151 provides an extension setup information file, in which information for extending the function of the client terminal 101 is described, to the client terminal 101.

Note that the local printer driver 303 (general-purpose software) has been incorporated in the operating system in advance. Further, the cloud printer driver 304 (cloud general-purpose software) has been also incorporated in the operating system in advance.

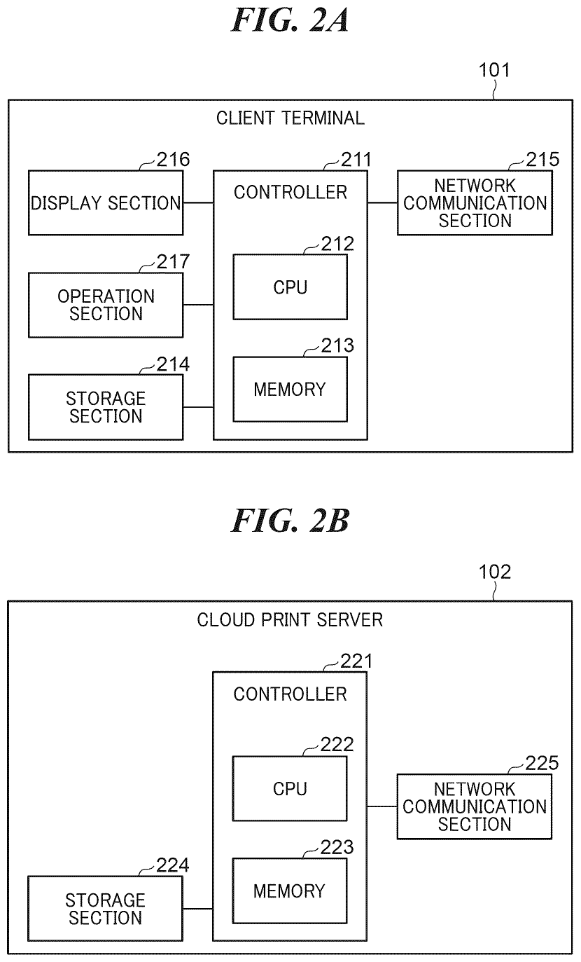

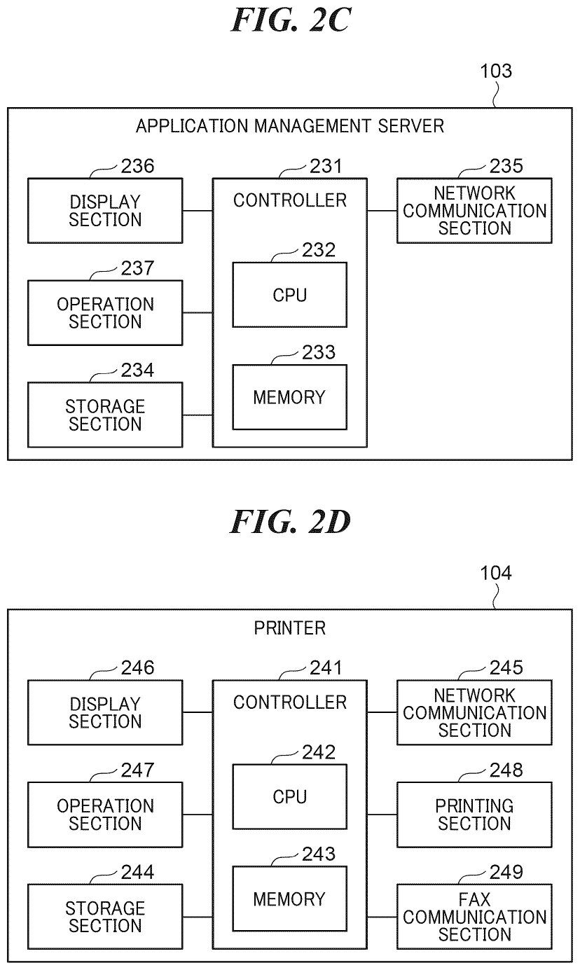

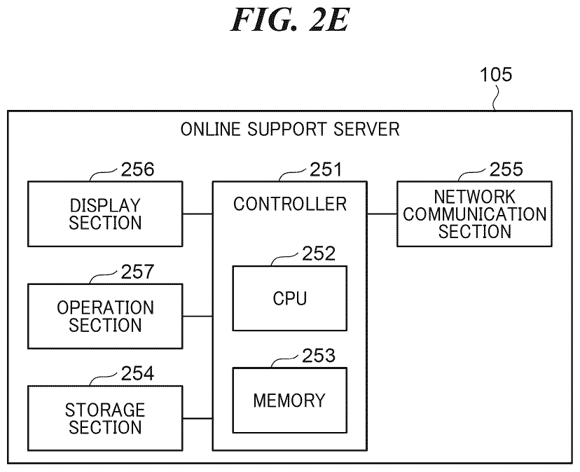

Next, hardware configurations of components of the printing system according to the present embodiment will be described with reference to FIGS. 2A to 2E.

FIG. 2A is a block diagram schematically showing a hardware configuration of the client terminal 101.

The client terminal 101 includes a display section 216, an operation section 217, a storage section 214, a controller 211, and a network communication section 215.

The storage section 214 is a nonvolatile storage device, such as a hard disk and a solid state drive (SSD), in which digital data can be stored and rewritten.

The controller 211 is formed by a central processing unit (CPU) 212 and a memory 213 and controls the overall operation of the client terminal 101. The CPU 212 loads a program stored in the storage section 214 into the memory 213 and executes the loaded program. The memory 213 is a main storage memory for the CPU 212 and is used as a work area and a temporary storage area for loading a variety of programs.

The network communication section 215 is a device that performs communication with the external network 107 and inputs and outputs digital data from and to an external server, a client terminal, and so forth.

The display section 216 is a device, such as a liquid crystal display, for displaying visual information to a user. The operation section 217 is a device for receiving an input from a user via a keyboard and a mouse. A device having both functions of the display section 215 and the operation section 217, such as a touch panel, can be used.

FIG. 2B is a block diagram schematically showing a hardware configuration of the cloud print server 102. The cloud print server 102 includes a storage section 224, a controller 221, and a network communication section 225. Note that the storage section 224, the controller 221, and the network communication section 225 are the same as those of the client terminal 101, and hence the description thereof is omitted. Note that although the cloud print server 102 will be described as a single communication apparatus having the hardware configuration shown in FIG. 2B, the cloud print server 102 can be formed by a plurality of communication apparatuses.

FIG. 2C is a block diagram schematically showing a hardware configuration of the application management server 103. The application management server 103 includes a display section 236, an operation section 237, a storage section 234, a controller 231, and a network communication section 235. Note that the display section 236, the operation section 237, the storage section 234, the controller 231, and the network communication section 235 are the same as those of the client terminal 101, and hence the description thereof is omitted. Note that although the application management server 103 will be described as a single communication apparatus having the hardware configuration shown in FIG. 2C, the application management server 103 can be formed by a plurality of communication apparatuses.

FIG. 2D is a block diagram schematically showing a hardware configuration of the printer 104. The printer 104 includes a display section 246, an operation section 247, a storage section 244, a controller 241, a network communication section 245, a printing section 248, and a FAX communication section 249.

The display section 246 is a device for displaying information to a user, such as a touch panel and a light emitting diode (LED) equipped in the printer 104. The operation section 247 is a device for receiving an input from a user and sometimes includes not only the touch panel, but also hard keys, such as numeric keys. The storage section 244 is a nonvolatile storage device, such as a hard disk and an SSD, in which digital data can be stored and rewritten. The controller 241 is formed by a CPU 242 and a memory 243 and controls the overall operation of the printer 104. The CPU 242 loads a program stored in the storage section 244 into the memory 243 and executes the loaded program. The memory 243 is a main storage memory for the CPU 242 and is used as a work area and a temporary storage area for loading a variety of programs.

The network communication section 245 is a device that performs communication with the external network 107 and mainly has a role of receiving print data and transmitting information indicating a state of the printer 104, such as an error, to e.g. an external server. The printing section 248 has an image forming section that forms an image on a sheet conveyed from a cassette or a tray. The image forming method is not particularly limited, but the electrophotographic method and the inkjet method can be used. A sheet on which an image has been formed by the image forming section is conveyed to a finishing apparatus (not shown) and subjected to finishing processing, such as stapling and punching. In the present embodiment, the printing section 248 will be described assuming that the above-mentioned finishing apparatus is also included in the printing section 248. The FAX communication section 249 performs FAX communication with an external apparatus equipped with the FAX function.

FIG. 2E is a block diagram schematically showing a hardware configuration of the online support server 105. The online support server 105 includes a display section 256, an operation section 257, a storage section 254, a controller 251, and a network communication section 255. Note that the display section 256, the operation section 257, the storage section 254, the controller 251, and the network communication section 255 are the same as those of the client terminal 101, and hence the description thereof is omitted. Note that although the online support server 105 will be described as a single communication apparatus having the hardware configuration shown in FIG. 2E, the online support server 105 can be formed by a plurality of communication apparatuses.

Next, a software configuration of the client terminal 101 will be described.

FIG. 3 is a block diagram schematically showing the software configuration of the client terminal 101 appearing in FIG. 1. As shown in FIG. 3, the client terminal 101 includes a document generation application 301, an operating system (OS) 302, and a print setting extension application 307. Processing operations performed by these applications are realized by the CPU 212 of the client terminal 101 executing programs stored e.g. in the storage section 214.

The document generation application 301 is an application having functions of generating, editing, and displaying a document. and is, for example, a document generation application or a spreadsheet application.

The OS 302 is e.g. Windows 11 (registered trademark) of Microsoft (registered trademark). The OS 302 includes the local printer driver 303 (general-purpose software), the cloud printer driver 304, a print spooler 305, and a toast management section 306.

The local printer driver 303 (general-purpose software) is e.g. the Internet Printing Protocol (IPP) Class Driver. The IPP Class Driver is a printer driver that executes print processing according to the specification of a standard printing protocol referred to as the IPP. The local printer driver 303 is not a printer driver specific to a model of an image processing apparatus but a standard driver which can be applied to various types of image processing apparatuses regardless of a maker and a model. Note that the local printer driver 303 is equipped with only standard functions, and hence, differently from a printer driver specific to a model, out of a plurality of functions equipped in the image processing apparatus, only functions supported by the local printer driver 303 are usable.

The cloud printer driver 304 (general-purpose software) is e.g. the UP Class Driver. The UP Class Driver is a printer driver used in Universal Print which is one form of cloud printing that performs printing via the cloud print server 102. The cloud printer driver 304 is not a printer driver specific to a model of an image processing apparatus, either, but a standard driver which can be applied to various types of image processing apparatuses regardless of a maker and a model. Note that the cloud printer driver 304 is also equipped with only standard functions, and hence differently from the printer driver specific to a model, out of a plurality of functions equipped in the image processing apparatus, only functions supported by the cloud printer driver 304, are usable.

The local printer driver 303 or the cloud printer driver 304 converts a document generated by the document generation application 301 to intermediate image data, described hereinafter, according to an instruction received from a user. Further, the local printer driver 303 or the cloud printer driver 304 passes this intermediate image data to the print spooler 305.

The print spooler 305 generates FAX transmission data based on the intermediate image data received from the local printer driver 303 or the cloud printer driver 304. The print spooler 305 transmits the FAX transmission data to an image processing apparatus as a connection destination directly or via the cloud print server 102. The toast management section 306 acquires information indicating success or failure in execution of a job corresponding to an instruction received by the OS 302 and displays a toast notification including an execution result of the job on the display section 216 based on the acquired information.

The print setting extension application 307 is an application for extending the functions of the local printer driver 303 and the cloud printer driver 304. The print setting extension application 307 includes a print setting user interface (UI) section 308. The print setting UI section 308 displays a printing setting UI 309 for making print settings and a FAX setting UI 310 for making FAX settings on the display section 216.

Next, a process performed when a document generated by the document generation application 301 is transmitted by FAX in the printing system according to the present embodiment will be described.

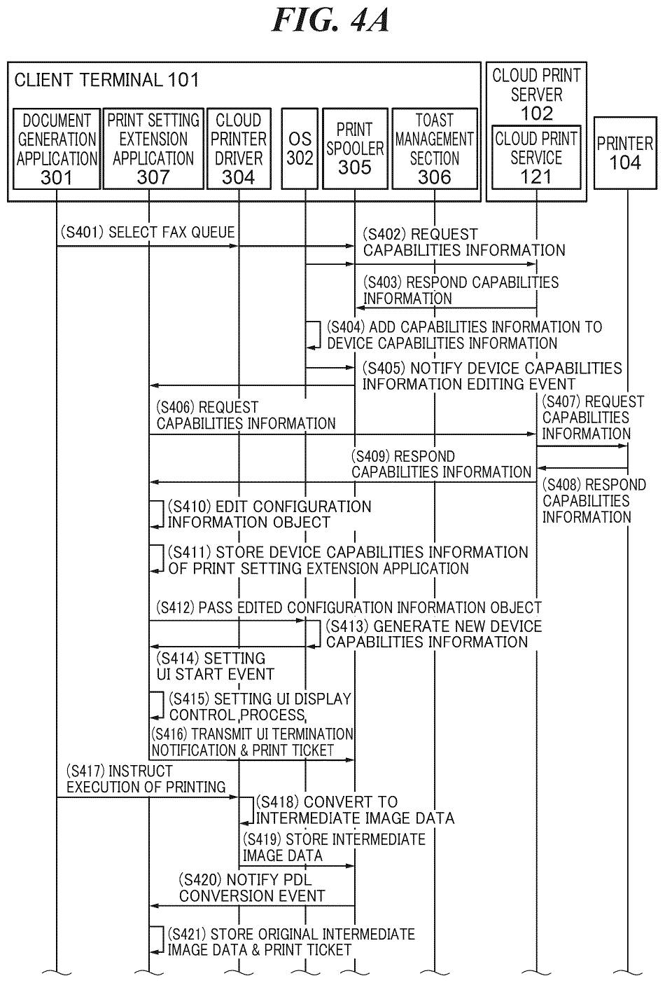

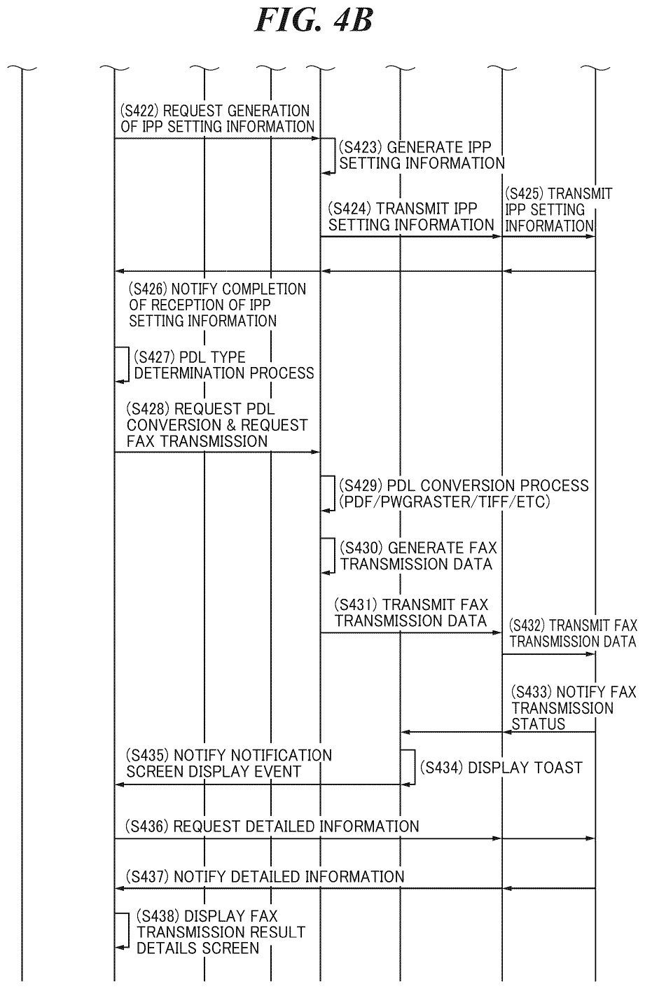

FIGS. 4A and 4B are sequence diagrams of a FAX transmission control process executed by the printing system shown in FIG. 1. For example, the FAX transmission control process in FIGS. 4A and 4B is performed by the client terminal 101, the cloud print server 102, and the printer 104. Processing operations performed by the client terminal 101 are realized by the CPU 212 of the client terminal 101 loading a program stored in the storage section 214 into the memory 213 and executing the loaded program. Processing operations performed by the cloud print server 102 are realized by the CPU 222 of the cloud print server 102 loading a program stored in the storage section 224 into the memory 223 and executing the loaded program. Processing operations performed by the printer 104 are realized by the CPU 242 of the printer 104 loading a program stored in the storage section 244 into the memory 243 and executing the loaded program.

Referring to FIGS. 4A and 4B, first, a user selects a FAX queue for causing the printer 104 as the connection destination to transmit a document generated by the document generation application 301 (S401). Note that in the client terminal 101, the information of the printer 104 as the connection destination, such as an IP address of the printer 104 and a hardware ID of the printer 104, has been registered in the memory 213 in advance. For example, when the client terminal 101 is connected to the network, the IP address of the printer 104 and the hardware ID of the printer 104 are acquired and registered in the memory 213.

Then, the OS 302 requests capabilities information of the printer 104 as the connection destination to a cloud print service 121 via the print spooler 305 (S402). The cloud print service 121 having received this request transmits the capabilities information to the print spooler 305 as a response (S403). This capabilities information includes, for example, information on standard functions out of the functions equipped in the printer 104. The capabilities information is information on functions, out of functions equipped in the printer 104 and associated with FAX, which are other than an extended function unique to a maker (vendor) of the printer 104. Further, this capabilities information includes a FAX-associated flag indicating one of “TRUE” indicating that the printer 104 is equipped with the FAX function and “FALSE” indicating that the printer 104 is not equipped with the FAX function. Note that in a case where the printer 104 is an apparatus which does not support the FAX-associated flag, the FAX-associated flag is not included in this capabilities information. The print spooler 305 passes the received capabilities information to the OS 302.

Then, the OS 302 adds the capabilities information transmitted from the cloud print service 121 to device capabilities information including information on functions held by the OS 302 (S404). With this, in the device capabilities information, the information on the standard functions held by the printer 104 is included in addition to the functions held by the OS 302.

Then, the OS 302 notifies a device capabilities information editing event to the print setting extension application 307 (S405).

The print setting extension application 307 having received this notification requests the capabilities information of the printer 104 to the cloud print service 121 (S406). In the step S406, the capabilities information different in type from the capabilities information requested by the OS 302 in the step S402 is requested. The cloud print service 121 having received this request requests the capabilities information to the printer 104 by using the IPP protocol (S407).

The printer 104 transmits the requested capabilities information to the cloud print service 121 as a response (S408). This capabilities information is information of functions, out of the functions held by the printer 104, which have not been notified in the step S403, and is, for example, information on an extension function unique to the maker of the printer 104, out of the functions associated with FAX which are held by the printer 104.

Then, the cloud print service 121 transmits the capabilities information acquired from the printer 104 to the print setting extension application 307 as a response (S409). Then, upon receipt of the capabilities information from the cloud print service 121, the print setting extension application 307 edits a configuration information object (not shown) (S410). The configuration information object is a collection of data groups required to edit the device capabilities information. The print setting extension application 307 cannot directly edit the device capabilities information held by the OS 312. Therefore, in the present embodiment, the device capabilities information held by the OS 312 is changed by using the configuration information object.

Then, the print setting extension application 307 stores the capabilities information acquired as the response to the request in the step S402 and the capabilities information acquired as the response to the request in the step S406 in a data storage area of the print setting extension application 307 as the device capabilities information of its own (S411). Note that in a case where the printer 104 is an apparatus supporting the FAX-associated flag, the FAX-associated flag is included in this device capabilities information. Then, the print setting extension application 307 passes the edited configuration information object to the OS 302 (S412).

Upon receipt of the configuration information object from the print setting extension application 307, the OS 302 generates new device capabilities information by merging the device capabilities information held by the OS 302 itself and the device capabilities information added to the configuration information object (S413). When the new device capabilities information is generated, the OS 302 validates a print queue. This makes it possible to start the print setting UI section 308 of the print setting extension application 307.

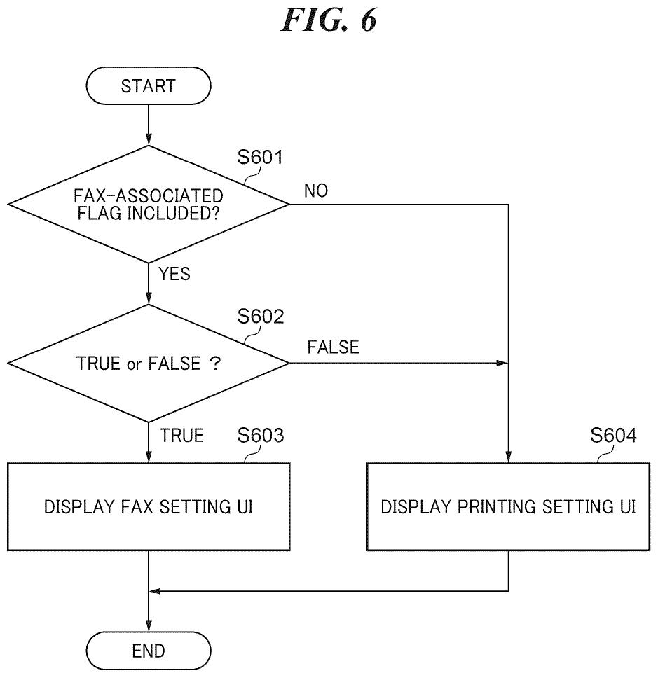

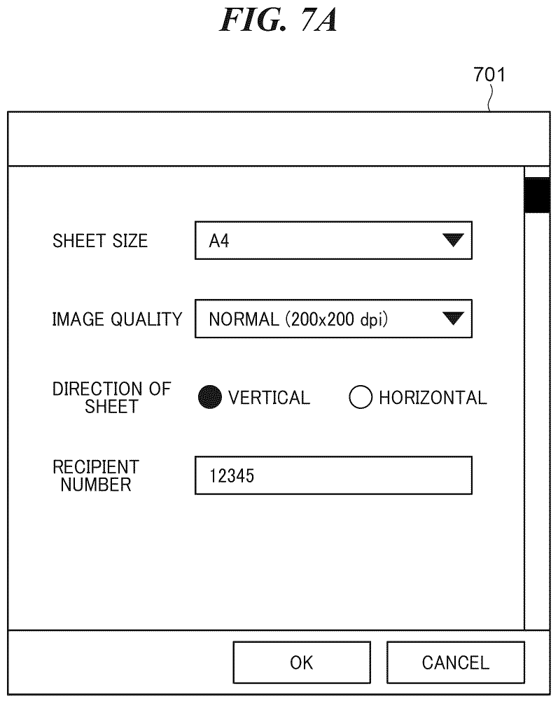

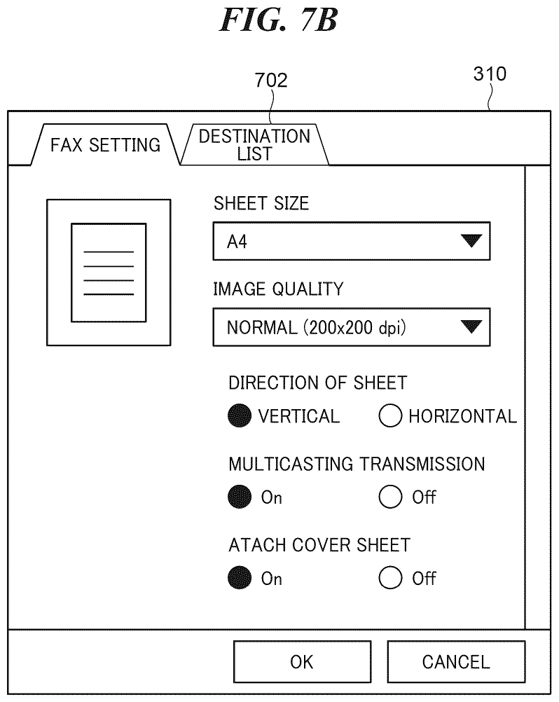

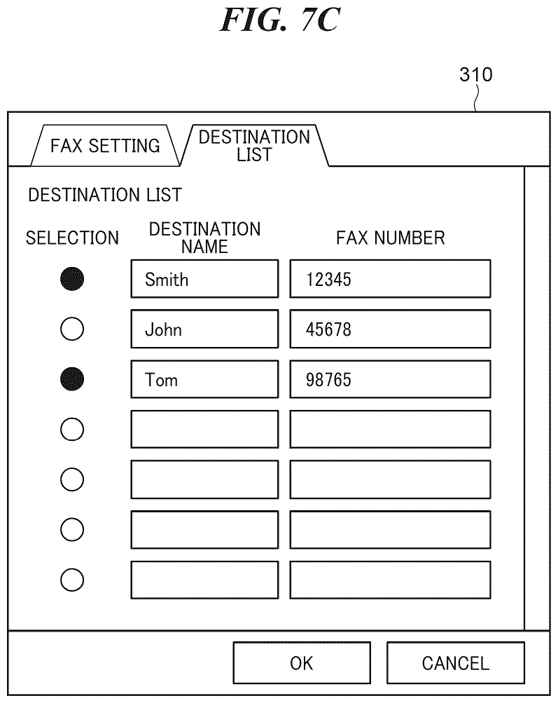

Upon receipt of a setting UI start event from the OS 302 (S414), the print setting extension application 307 performs a setting UI display control process, described hereinafter with reference to FIG. 6 (S415). In the step S415, for example, the FAX setting UI 310, described hereinafter with reference to FIG. 7B, which has an extension function of FAX, is displayed on the display section 216. On the FAX setting UI 310, it is possible to make not only settings of the FAX standard functions, such as a sheet size, image quality, and a direction of a sheet, but also settings of an extension function unique to the maker of the printer 104, such as multicasting transmission setting and cover sheet setting When the user makes FAX settings on the FAX setting UI 310, the print setting extension application 307 writes settings made on the FAX setting UI 310 into a print ticket. The print ticket refers to a file indicating print setting information, described in the XML. After that, the screen on the display section 216 is changed from the FAX setting UI 310 to a print setting screen provided by the document generation application 301.

Then, the print setting extension application 307 transmits a UI termination notification indicating that the setting on the FAX setting UI 310 is completed and the print ticket to the print spooler 305 (S416). The print spooler 305 stores the received UI termination notification and print ticket.

Then, the user provides an instruction for executing printing of a document via the document generation application 301 (S417). The cloud printer driver 304 converts the document acquired from the document generation application 301 to intermediate image data (S418). The intermediate image data is data generated before being converted to print data, such as PDL data, and is e.g. XML Paper Specification (XPS) data. Then, the cloud printer driver 304 stores this intermediate image data in the print spooler 305 (S419).

The print spooler 305 having received the intermediate image data notifies the print setting extension application 307 of a PDL conversion event (S420). The PDL conversion event refers to processing for converting the intermediate image data to PDL data which can be processed by the printer 104. Note that at this time, the print setting extension application 307 receives the intermediate image data and the print ticket stored in the step S416 from the print spooler 305 together with the PDL conversion event notification. The print setting extension application 307 stores the received intermediate image data in the data storage area of the print setting extension application 307 as the “original intermediate image data” together with the received print ticket (S421).

Then, the print setting extension application 307 requests the print spooler 305 to generate IPP setting information by using an API of the OS 302 (S422). The IPP setting information refers to print setting information defined by a combination of IPP attributes and IPP attribute values.

The print spooler 305 generates the IPP setting information according to this request (S423). In the step S423, the print spooler 305 generates the IPP setting information based on the print ticket saved in the step S416. Then, the print spooler 305 transmits the IPP setting information to the cloud print service 121 (S424).

The cloud print service 121 transmits the received IPP setting information to the printer 104 (S425).

The printer 104 having received the IPP setting information notifies completion of reception of the IPP setting information to the print setting extension application 307 via the cloud print service 121 and the print spooler 305 (S426).

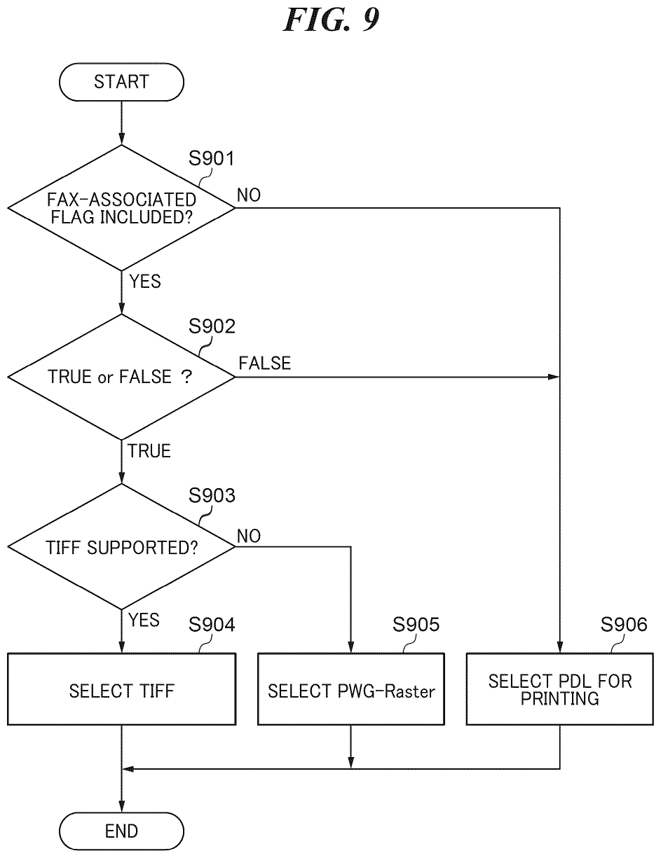

Then, the print setting extension application 307 performs a PDL type determination process, described hereinafter with reference to FIG. 9 (S427). In the step S427, a PDL type to which the intermediate image data is converted by a PDL conversion process in a step S429, described hereinafter, is selected based on the device capabilities information stored in the data holding area of the print setting extension application 307. For example, in a case where the FAX-associated flag included in this device capabilities information indicates “TRUE”, one of PWG-Raster and TIFF is selected as the PDL type to which the intermediate image data is converted by the PDL conversion process in the step S429, described hereinafter.

Then, the print setting extension application 307 passes the original intermediate image data stored in the data holding area of the print setting extension application 307 and the PDL type information indicating the type selected in the step S427, to the print spooler 305. Note that in a case where settings of the FAX extension function have been made on the FAX setting UI 310, the print setting extension application 307 performs processing associated with this extension function on the original intermediate image data. For example, in a case where the setting for attaching a cover sheet has been made on the FAX setting UI 310, the print setting extension application 307 performs processing for adding data of the cover sheet to the original intermediate image data. The cover sheet refers to a first or last page on which a name of the sender and the like are written so as to make the sender of the FAX identifiable. For example, the control is performed such that a UI for receiving a name of a sender is displayed on the FAX setting UI 310 and the received name is caused to be included in the data of the cover sheet. Further, the print setting extension application 307 can display a UI for receiving information of e.g. a message to a recipient other than the name of the sender, and cause the received message to be included in the data of the cover sheet. Further, the print setting extension application 307 can acquire user information, such as a user name and a user ID, of a user having logged in the client terminal 101 from the memory 213 and cause the acquired user information to be included in the data of the cover sheet. The print setting extension application 307 passes the processed intermediate image data to the print spooler 305 together with the PDL type information. Further, the print setting extension application 307 sends a PDL conversion request and a FAX transmission request to the print spooler 305 (S428). In this FAX transmission request, one or more set destinations are included, and a command for transmitting the transmission data to the one or more set destinations is included.

Upon receipt of the FAX transmission request, the print spooler 305 starts processing for transmission. The print spooler 305 performs the PDL conversion process for converting the acquired original intermediate image data (or processed intermediate image data) to the PDL of the type indicated by the acquired PDL type information (S429). Then, the print spooler 305 generates FAX transmission data based on the data obtained by the PDL conversion process (S430). The FAX transmission data is data to be transmitted by the printer 104 to the one or more apparatuses as the destinations set according to the IPP protocol. In this FAX transmission data, one or more set destinations and the generated cover sheet data are included.

The print spooler 305 transmits the generated FAX transmission data to the cloud print service 121 via the FAX queue (S431).

The cloud print service 121 transmits the FAX transmission data acquired from the print spooler 305 to the printer 104 (S432). The printer 104 transmits the received FAX transmission data to the one or more destinations set by the user by FAX.

Then, the printer 104 notifies a FAX transmission status indicating a success or a failure in the FAX transmission processing to the toast management section 306 of the OS 302, via the cloud print service 121 (S433).

The toast management section 306 displays a toast indicating a success or a failure in the FAX transmission processing on the display section 216 based on this FAX transmission status (S434). Then, when a user's click operation on this toast is received, the toast management section 306 notifies a notification screen display event to the print setting extension application 307 (S435).

The print setting extension application 307 having received the notification screen display event requests detailed information on an execution result of the FAX transmission processing to the printer 104 via the cloud print service 121 (S436).

The printer 104 having received this request notifies the detailed information on the execution result of the FAX transmission processing to the print setting extension application 307 via the cloud print service 121 (S437).

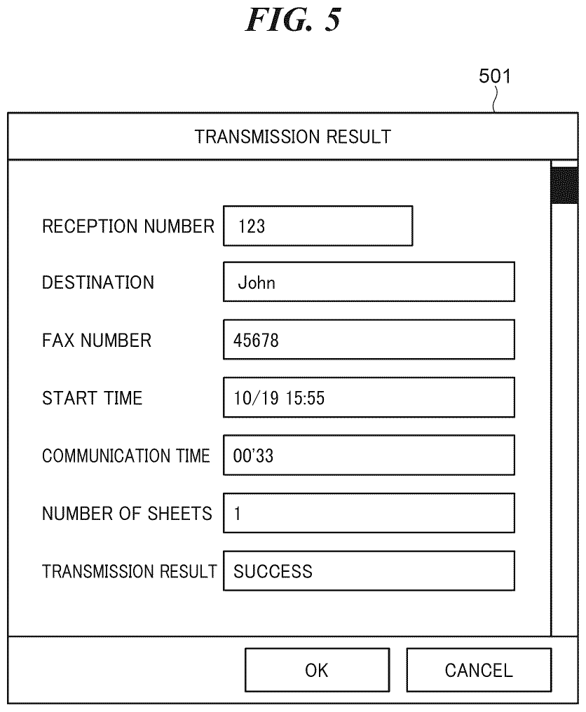

The print setting extension application 307 displays a FAX transmission result details screen 501 shown in FIG. 5 on the display section 216 based on the received detailed information (S438). On the FAX transmission result details screen 501, not only the information indicating a success or a failure in the FAX transmission processing, but also detailed information, such as a reception number, a destination, a FAX number of the destination, a start time of the FAX transmission processing, a communication time of the FAX transmission processing, and the number of sheets transmitted by FAX, are displayed. After that, the FAX transmission control process is terminated.

Note that although in the above-described FAX transmission control process in FIGS. 4A and 4B, the case where FAX transmission is performed by the cloud print has been described by way of example, the same process is performed also in a case where FAX transmission is performed by the local print. In a case where FAX transmission is performed by the local print, the client terminal 101 directly communicates with the printer 104 without using the cloud print service 121.

FIG. 6 is a flowchart of the setting UI display control process in the step S415 in FIG. 4A. The setting UI display control process in FIG. 6 is realized by the CPU 212 of the client terminal 101 loading a program stored in the storage section 214 into the memory 213 and executing the loaded program.

Referring to FIG. 6, the print setting extension application 307 determines whether or not the FAX-associated flag is included in the device capabilities information thereof, which is stored in the step S411 (S601).

If it is determined in the step S601 that the FAX-associated flag is included in this device capabilities information, the print setting extension application 307 determines whether this FAX-associated flag indicates “TRUE” or “FALSE” (S602).

If it is determined in the step S602 that the FAX-associated flag indicates “TRUE”, i.e. if the printer 104 is equipped with the FAX function, the setting UI display control process proceeds to a step S603. In the step S603, the print setting extension application 307 displays the FAX setting UI 310 on the display section 216 based on this device capabilities information. Here, the FAX setting UI will be described.

FIG. 7A is a diagram showing an example of a FAX setting UI 701 displayed by the standard driver of the OS 302, appearing in FIG. 3. On the FAX setting UI 701, it is possible to make settings with respect to setting items, such as a sheet size, image quality, a direction of a sheet, and a FAX number of a recipient.

FIGS. 7B and 7C are diagrams each showing an example of the FAX setting UI 310 displayed by the print setting extension application 307 appearing in FIG. 3. In the present embodiment, in the step S603, not the above-mentioned FAX setting UI 701, but the FAX setting UI 310 is displayed on the display section 216. As shown in FIG. 7B, on the FAX setting UI 310, not only the above-mentioned setting items, such as a sheet size, image quality, and a direction of a sheet, but also a setting item of multicasting transmission and a setting item of a cover sheet are included. The multicasting transmission is a transmission method in which a plurality of destinations are set, and the same image data is transmitted to the plurality of set destinations according to one transmission instruction from a user. Further, when a tab 702 is selected, the screen shown in FIG. 7C is displayed, whereby it is possible to select FAX numbers of one or more destinations from a destination list registered in the memory 213 in advance. When a transmission instruction is provided in a state in which a plurality of destinations are selected on this screen shown in FIG. 7C, the multicasting transmission of transmission data to the plurality of destinations is performed. Functions corresponding to the setting items which are not included in the FAX setting UI 701 (the multicasting transmission, the cover sheet, and the destination list) displayed by the standard driver of the OS 302 are functions which are not supported by the standard driver of the OS 302. Further, these functions are the functions included in the device capabilities information stored in the step S411, i.e. part of the FAX functions held by the printer 104. Thus, in the present embodiment, it is possible to acquire the capabilities information of FAX from the printer 104 and receive the setting of functions based on the acquired capabilities information. After completion of S603, the setting UI display control process is terminated.

If it is determined in the step S601 that the FAX-associated flag is not included in this device capabilities information, i.e. the printer 104 is an apparatus which does not support the FAX-associated flag, the setting UI display control process proceeds to a step S604. Further, if it is determined in the step S602 that this FAX-associated flag indicates “FALSE”, i.e. if the printer 104 is not equipped with the FAX function, the setting UI display control process also proceeds to the step S604.

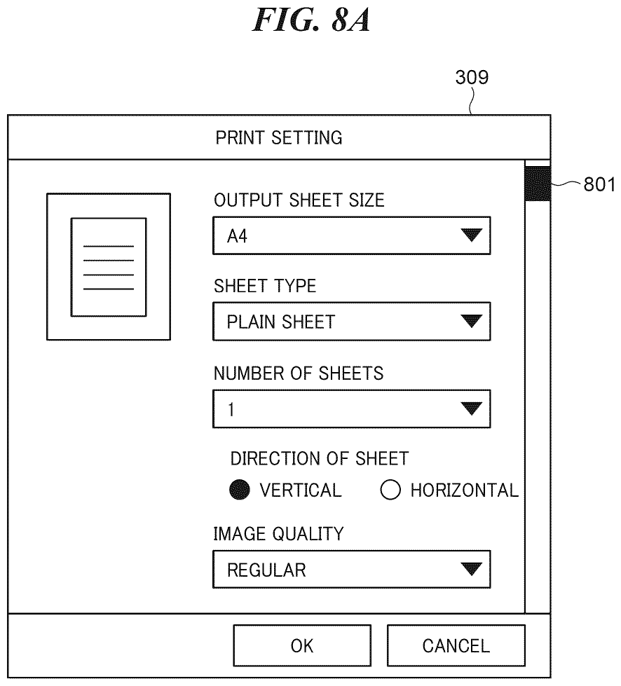

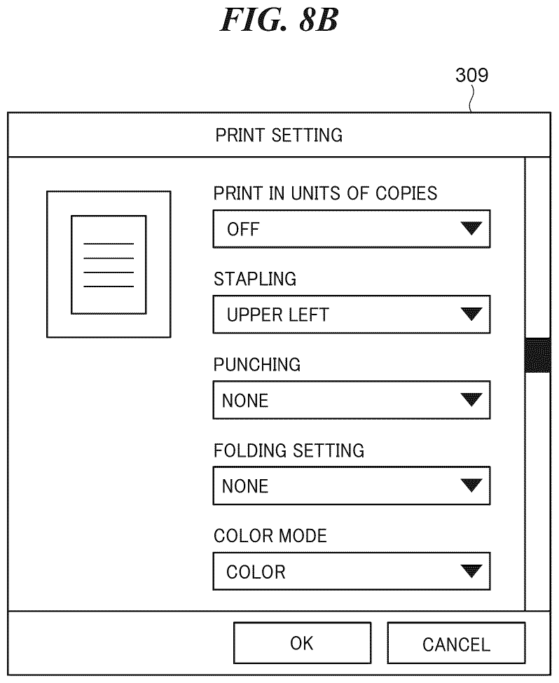

In the step S604, the print setting extension application 307 displays the setting UI which does not include the setting items of the FAX extension function on the display section 216. Specifically, the print setting extension application 307 displays the printing setting UI 309 shown in FIG. 8A on the display section 216. On the printing setting UI 309, a plurality of setting items associated with the printing setting are included. On the printing setting UI 309, when the user operates a scroll bar 801, it is possible to make a setting on another setting item which has not been displayed. Note that in the step S604, a message to the effect that the printer 104 as the connection destination is not equipped with the FAX function can be displayed on the printing setting UI 309. After completion of the step S604, the setting UI display control process is terminated.

Note that in the present embodiment, the FAX setting UI 310 displayed in the step S603 can be configured to be changeable to the printing setting UI 309 by a tab operation performed by the user.

Further, in the present embodiment, in the step S604, as a setting UI which does not include the setting items of the FAX extension function, a setting UI formed by the same setting items as those of the FAX setting UI 701 can be displayed. With this, in a case where the printer 104 as the connection destination is not equipped with the FAX function, it is possible to prevent a user from erroneously making settings of the unavailable FAX extension function.

Further, in the present embodiment, the configuration of the FAX setting UI can be controlled based on whether or not the information on the FAX extension function is included in the device capabilities information. For example, in a case where the information on the FAX extension function is included in the device capabilities information, a FAX setting UI including the setting item of the FAX extension function, e.g. the FAX setting UI 310 is displayed on the display section 216. On the other hand, in a case where the information of the FAX extension function is not included in the device capabilities information, a FAX setting UI which does not include the setting items of the FAX extension function, e.g. the FAX setting UI 701 is displayed on the display section 216. With this control, it is possible to make FAX settings adapted to the image processing apparatus as the connection destination.

FIG. 9 is a flowchart of the PDL type determination process in the step S427 in FIG. 4B. The PDL type determination process in FIG. 9 is realized by the CPU 212 of the client terminal 101 loading a program stored in the storage section 214 into the memory 213 and executing the loaded program.

Referring to FIG. 9, first, the print setting extension application 307 determines whether or not the FAX-associated flag is included in the device capabilities information of its own stored in the step S411 (S901).

If it is determined in the step S901 that the FAX-associated flag is included in this device capabilities information, the print setting extension application 307 determines whether this FAX-associated flag indicates “TRUE” or “FALSE” (S902).

If it is determined in the step S902 that this FAX-associated flag indicates “TRUE”, i.e. the printer 104 is equipped with the FAX function, the PDL type determination process proceeds to a step S903. In the step S903, the print setting extension application 307 determines based on the device capabilities information whether or not TIFF is supported in the FAX function.

If it is determined in the step S903 that TIFF is supported in the FAX function, the print setting extension application 307 selects TIFF as the PDL type to which the intermediate image data is converted in the step S429 (S904). Then, the PDL type determination process is terminated.

If it is determined in the step S903 that TIFF is not supported in the FAX function, the print setting extension application 307 selects the PWG-Raster as the PDL type to which the intermediate image data is converted in the step S429 (S905). Then, the PDL type determination process is terminated.

If it is determined in the step S901 that FAX-associated flag is not included in this device capabilities information, i.e. the printer 104 is an apparatus which does not support the FAX-associated flag, the PDL type determination process proceeds to a step S906. Further, if it is determined in the step S902 that this FAX-associated flag indicates “FALSE”, i.e. if the printer 104 is not equipped with the FAX function, the PDL type determination process also proceeds to the step S906. In the step S906, the print setting extension application 307 selects the PDL for printing (such as the PDF) as the PDL type to which convert the intermediate image data is converted in the step S429. Then, the PDL type determination process is terminated.

According to the above-described embodiment, the client terminal 101 acquires the FAX capabilities information of the printer 104 connected to the client terminal 101 and receives the settings of the functions based on this capabilities information. This makes it possible to make FAX settings adaptable to the image processing apparatus as the connection destination.

Further, in the above-described embodiment, if it is determined based on the FAX-associated flag that the printer 104 has the FAX function, the FAX setting UI 310 including the setting items of the extension function based on the acquired capabilities information is displayed. With this, in a case where the printer 104 as the connection destination has the FAX function, it is possible to cause a user to make settings of the FAX extension function of the printer 104, and as a result, the user is enabled to make the best use of the FAX extension function of this printer 104.

Further, in the above-described embodiment, the FAX extension function is the multicasting transmission function. With this, in a case where the printer 104 as the connection destination has the FAX multicasting transmission function, a user is enabled to use the FAX multicasting transmission function.

Further, in the above-described embodiment, one of the FAX extension functions is the function of attaching a cover sheet. With this, in a case where the printer 104 as the connection destination has the function of attaching a cover sheet, it is possible to realize FAX transmission of FAX transmission data to which a cover sheet is attached.

Further, in the above-described embodiment, one of the FAX extension functions is the destination list function. With this destination list function, in a case where the printer 104 as the connection destination has the destination list function, it is possible to cause a user to easily set a destination of FAX transmission.

Further, in the above-described embodiment, if it is determined based on the FAX-associated flag that the printer 104 does not have the FAX function, the setting UI which does not include the setting items of the FAX extension function is displayed on the display section 216. With this, in a case where the printer 104 as the connection destination is not equipped with the FAX function, it is possible to prevent a user from erroneously making settings of the FAX extension function which is unusable.

Further, in the above-described embodiment, if it is determined based on the FAX-associated flag that the printer 104 does not have the FAX function, the printing setting UI 309 is displayed on the display section 216. With this, in a case where the printer 104 as the connection destination is not equipped with the FAX function, it is possible to positively prevent a user from erroneously making FAX settings.

Further, in the above-described embodiment, the FAX transmission result details screen 501 is displayed on the display section 216. This enables a user to easily know a success or a failure in FAX transmission processing.

Next, a printing system including an information processing apparatus according to a second embodiment of the present invention will be described.

The second embodiment is basically the same in the configuration and effects as the above-described first embodiment but is different from the first embodiment in that the FAX transmission result details screen 501 is displayed according to an instruction received from a user. Therefore, description of the redundant configuration and effects is omitted, and the description will be given of the different configuration and effects.

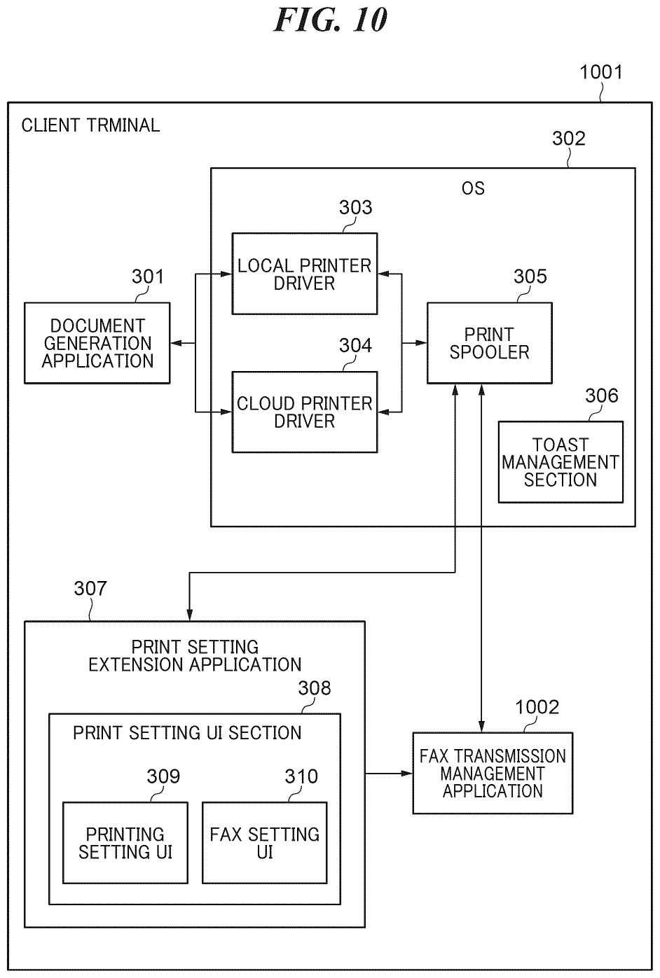

Note that in the printing system in the second embodiment, a client terminal 1001 as the information processing apparatus included in this printing system is the same as the above-described client terminal 101. However, the client terminal 1001 is different in software configuration from the above-described client terminal 101. So, the software configuration of the client terminal 1001 will be described with reference to FIG. 10.

FIG. 10 is a block diagram schematically showing the software configuration of the client terminal 1001 as the information processing apparatus according to the second embodiment. As shown in FIG. 10, the client terminal 1001 includes, as the software, not only the above-described document generation application 301, OS 302, and print setting extension application 307, but also a FAX transmission management application 1002. Processing operations performed by these applications are realized by the CPU 212 of the client terminal 1001 executing programs stored e.g. in the storage section 214.

The FAX transmission management application 1002 acquires detailed information of an execution result of FAX transmission processing, which has been transmitted from the printer 104, according to an instruction received from a user, and displays the FAX transmission result details screen 501 on the display section 216 based on the acquired detailed information.

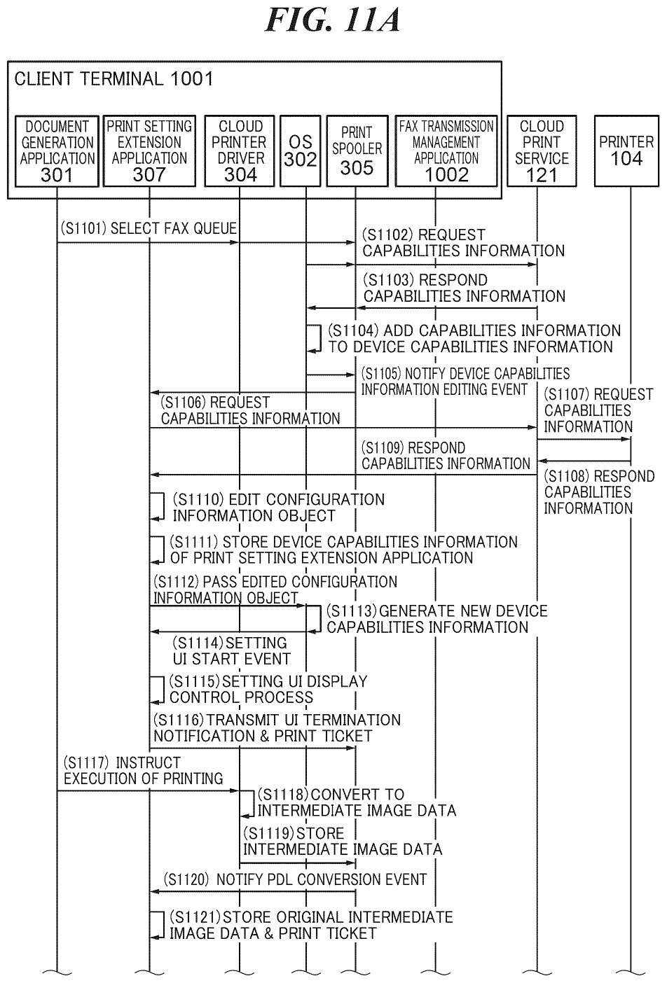

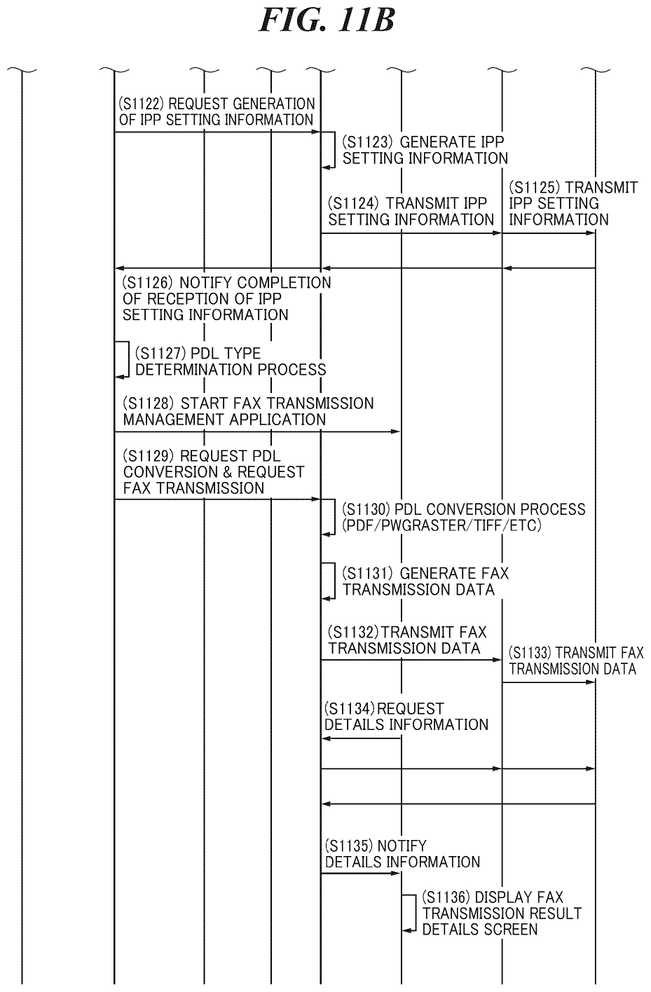

FIGS. 11A and 11B are sequence diagrams of a FAX transmission control process executed by the printing system according to the second embodiment. Note that the FAX transmission control process in FIGS. 11A and 11B is similar to the above-described FAX transmission control process in FIGS. 4A and 4B, and particularly, the following description will be given of different contents from the FAX transmission control process in FIGS. 4A and 4B. In the FAX transmission control process in FIGS. 11A and 11B, processing operations performed by the client terminal 1001 are realized by the CPU 212 of the client terminal 1001 loading a program stored in the storage section 214 into the memory 213 and executing the loaded program. Processing operations performed by the cloud print server 102 are realized by the CPU 222 of the cloud print server 102 loading a program stored in the storage section 224 into the memory 223 and executing the loaded program. Processing operations performed by the printer 104 are realized by the CPU 242 of the printer 104 loading a program stored in the storage section 244 into the memory 243 and executing the loaded program.

Referring to FIGS. 11A and 11B, steps S1101 to S1127 which are the same processing operations as the steps S401 to S427 are performed.

Then, the print setting extension application 307 starts the FAX transmission management application 1002 (S1128). Then, steps S1129 to S1133 which are the same processing operations as the steps S428 to S432 are performed.

Then, the FAX transmission management application 1002 requests detailed information of an execution result of the FAX transmission processing to the printer 104 via the print spooler 305 and the cloud print service 121, according to a detailed information display instruction provided by the user (S1134). In the present embodiment, for example, the user can provide the detailed information display instruction by selecting a state display button (not shown) displayed on the display section 216.

Upon receipt of this request, the printer 104 notifies the detailed information of an execution result of the FAX transmission processing to the FAX transmission management application 1002 via the cloud print service 121 and the print spooler 305 (S1135).

The FAX transmission management application 1002 displays the FAX transmission result details screen 501 on the display section 216 based on the received detailed information (S1136), followed by terminating the FAX transmission control process.

In the above-described embodiment, the FAX transmission management application 1002 displays the FAX transmission result details screen 501 on the display section 216 according to an instruction provided by a user. With this, the user can confirm the FAX transmission result details screen 501 not only at a timing of completion of the FAX transmission processing, but also at a desired timing.

Note that in the present embodiment, the FAX transmission management application 1002 can be configured to request the detailed information of an execution result of the FAX transmission processing to the printer 104 via the cloud print service 121 without using the print spooler 305 and thereby acquire the detailed information. Specifically, in the above-described embodiment, the example has been described, in which the could printer driver 304 converts a document to intermediate image data, and the FAX transmission data is transmitted to the printer 104 via the cloud print service 121. However, the present invention is not limited to this, but the processing operations in the steps S418 and S419 in the first embodiment can be executed by the local printer driver 303 (general-purpose software). In this case, the FAX transmission data can be transmitted to the printer 104 in the step S432 without using the cloud print server 102. Further, the processing operations in the steps S1118 and S1119 in the second embodiment can be executed by the local printer driver 303 (general-purpose software), and the FAX transmission data can be transmitted to the printer 104 in the step S432 without using the cloud print service 121.

### Other Embodiments

Embodiment(s) of the present invention can also be realized by a computer of a step System or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the step System or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The step Scope of the following claims is to be accorded the broadest interpretation so as to encompass all such modifications and equivalent structures and functions.

This application claims the benefit of Japanese Patent Application No. 2024-010796 filed Jan. 29, 2024, which is hereby incorporated by reference herein in its entirety.

What is claimed is:

1. A non-transitory computer-readable storage medium storing an application program for causing an information processing apparatus to execute a method of supporting general-purpose software incorporated in an operating system in advance by executing the application program,
the method comprising:
acquiring FAX capabilities information of an image processing apparatus;
receiving settings of functions based on the FAX capabilities information;
causing the general-purpose software to generate image data based on the settings; and
causing the image processing apparatus to execute processing for transmitting the image data by FAX.

2. The storage medium according to claim 1, wherein the method further comprises:
receiving a predetermined flag which is a predetermined flag transmitted from the image processing apparatus and indicates whether or not the image processing apparatus has a FAX function, and
wherein in a case where it is determined based on the predetermined flag that the image processing apparatus has the FAX function, a setting UI for making FAX settings, which is a setting UI including setting items of an extension function based on the FAX capabilities information, is displayed.

3. The storage medium according to claim 2, wherein the FAX extension function is a multicasting transmission function.

4. The storage medium according to claim 2, wherein the FAX extension function is a function of attaching a cover sheet.

5. The storage medium according to claim 2, wherein the FAX extension function is a destination list function.

6. The storage medium according to claim 2, wherein in a case where it is determined based on the predetermined flag that the image processing apparatus does not have the FAX function, a setting UI which does not include setting items of an extension function based on the FAX capabilities information is displayed.

7. The storage medium according to claim 6, wherein the setting UI which does not include setting items of an extension function based on the FAX capabilities information is a setting UI for making print settings.

8. The storage medium according to claim 1, wherein the method further comprises:
displaying, when the FAX transmission processing performed by the image processing apparatus is terminated, a notification screen concerning a success or a failure of this FAX transmission processing.

9. The storage medium according to claim 1, wherein the method further comprises:
starting a predetermined application that performs control to display the notification screen concerning a success or a failure of the FAX transmission processing performed by the image processing apparatus, and
wherein the predetermined application performs control to display the notification screen according to an instruction provided by a user.

10. The storage medium according to claim 1, wherein the method further comprises:
controlling a configuration of a setting UI for making FAX settings based on whether or not information on a FAX extension function is included in the FAX capabilities information.

11. An information processing apparatus that is equipped with an operating system and an application program for supporting general-purpose software incorporated in the operating system in advance, comprising:
an acquisition unit configured to acquire FAX capabilities information of an image processing apparatus;
a reception unit configured to receive settings of functions based on the FAX capabilities information;
a generation unit configured to cause the general-purpose software to generate image data based on the settings; and
an execution unit configured to cause the image processing apparatus to execute processing for transmitting the image data by FAX.

12. A method of controlling an information processing apparatus that is equipped with an operating system and an application program for supporting general-purpose software incorporated in the operating system in advance, comprising:
acquiring FAX capabilities information of an image processing apparatus;
receiving settings of functions based on the FAX capabilities information;
causing the general-purpose software to generate image data based on the setting; and
causing the image processing apparatus to execute processing for transmitting the image data by FAX.
